(19) United States
(12) Patent Application Publication
(10) Pub. No.: US 2004/0215466 A1
(43) Pub. Date: Oct. 28, 2004

(54) Digital audio manipulator

(76) Inventor: Temeca Katherine Taylor, Jamaica, NY (US)

Correspondence Address: Temeca Taylor, 115-26 646th St., Jamaica, NY, 11436, US

(21) Appl. No.: 09/706,586

(22) Filed: Aug. 6, 2001

(51) Int. Cl. G10L 19/00

(52) U.S. Cl. 704/500

(57) ABSTRACT

A digital audio player with (a) compartment for holding compact discs. This digital audio manipulator has the capability of playing different types of digital audio files from different types of compact discs. This digital audio manipulator can transfer information with computers or other digital audio players.

### FIELD AND BACKGROUND OF INVENTION

The invention relates to an audio player that is not limited to playing one type of digital audio file from one type of compact disc. It is capable of, but is not limited to, playing, recording, rewinding, fast-forwarding, pausing, and storing various types of digital audio from various types of compact discs. These compact discs include, but are not limited to, compact disc, compact disc-recordable, and compact-disc rewriteable. This device can be made portable.

### SUMMARY OF THE INVENTION

An audio device that can manipulate various types of digital audio from various types of compact discs. It has a computer chip for data storage. It has a visual display for showing information. It has an device for transferring information with computers or other portable audio devices.

What is claimed:

1. An audio device comprising
(a) a housing for a compact disc
(b) in said housing a device for manipulating digital audio files (these types can include, but is not limited to mpeg audio layer-3 files, .wav files, etc)
(c) in said housing a device for manipulating digital audio files from different types of Compact Discs (these types can include, but are not limited to CD, CD-R, CD-RW, etc)

2. Said device in claim 1 has visual display for displaying information.

3. Device in claim 1 has physical buttons and/or knobs for user input or manipulation.

4. Device in claim 1 has outlet for an output device such as speakers or headphones, etc.

5. Device in claim 1 has computer chip for both long-term and short-term data storage.

6. Device in claim 1 has an input device for transferring data into computer chip in claim 5.

7. Device in claim 1 can also transfer information from computer chip in claim 5 with other computers or other portable audio devices.

8. This device has the capability of being portable.
